(19) United States
(12) Patent Application Publication
(10) Pub. No.: US 2026/0286057 A1
(43) Pub. Date: Sep. 24, 2026

(54) POLYMERISATION OF SILOXANE POLYMERS

(71) Applicants: Dow Global Technologies LLC, Midland, MI (US); Dow Silicones Corporation, Midland, MI (US)

(72) Inventors: Stephanie Barbon, Midland, MI (US); John Roberts, Midland, MI (US); Michael Molnar, Freeland, MI (US)

(21) Appl. No.: 19/475,623

(22) PCT Filed: May 20, 2024
(86) PCT No.: PCT/US2024/030193

§ 371 Date: Oct. 15, 2025

Related U.S. Application Data
(60) Provisional application No. 63/468,860, filed on May 25, 2023.

(51) Int. Cl. C08G 77/10; C08G 77/08

(52) U.S. Cl. CPC C08G 77/10; C08G 77/08

(57) ABSTRACT

This relates to a process for the polymerisation of siloxane polymers and copolymers, made by base catalysed ring-opening polymerisation of macrocyclic cyclosiloxane oligomers having from seven to ten siloxane units per macrocyclic cyclosiloxane oligomer. It also relates to the siloxane polymers and copolymers, made by the process and their uses.

This relates to a process for the polymerisation of siloxane polymers and copolymers, made by base catalysed ring-opening polymerisation of macrocyclic cyclosiloxane oligomers. It also relates to the siloxane polymers and copolymers, made by the process and their uses.

Cyclosiloxane oligomers are formed by the hydrolysis of diorganodichlorosilanes and can be isolated by distillation. They are critical intermediates in the silicone industry as they are used as one of the main building blocks in the preparation of siloxane polymers and copolymers.

Each siloxane unit in a cyclosiloxane oligomer is typically of the structure:

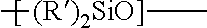

With each R′ group being the same or different and usually but not exclusively an alkyl group or an aryl group. Hence said cyclosiloxane oligomers may, for example, comprise dimethyl siloxane units, methylethyl siloxane units and/or phenylmethyl siloxane units in the ring.

The cyclosiloxane oligomers used as polymer building blocks typically have an average of from 3 to 5 siloxane units in each cyclosiloxane ring. Usually, but not always, the cyclosiloxane oligomers have an average of about 4 siloxane units in each cyclosiloxane ring because octamethylcyclotetrasiloxane is probably one of the most abundant cyclosiloxane feedstocks and is often found to be the purest of the distilled cyclosiloxanes. That said, examples of such cyclosiloxane oligomers having 3 to 5 siloxane units per molecule include octamethylcyclotetrasiloxane, hexamethylcyclotrisiloxane, decamethylcyclopentasiloxane, cyclotetra(phenylmethyl)siloxane and mixtures thereof. However, octamethylcyclotetrasiloxane is essentially the only cyclosiloxane used in homogeneous base-catalyzed ring opening polymerization.

Typically, the cyclosiloxane oligomers and mixtures thereof, undergo a polymerisation process involving the ring opening of the cyclosiloxane oligomers in the presence of acid or base catalysts optionally with suitably end-blocked linear/branched polydiorganosiloxanes (end-blockers). An equilibrium between the desired siloxane polymers and a mixture of cyclosiloxane compounds is created in the course of the polymerisation reaction. The resulting equilibrium largely depends on the nature and number of cyclosiloxane compound(s), the catalyst used and the polymerisation process temperature.

When utilising octamethylcyclotetrasiloxane as the starting material it also tends to be the prevalent cyclosiloxane as a result of the equilibration. Given the basic or acidic nature of the catalysts used, such polymerisation processes are generally terminated or quenched by the addition of a neutralizing agent designed to react with the chosen acid or base catalyst to render it non-active. Where possible, catalyst residues are preferably removed from the resulting polymer product by an appropriate separation method, e.g., filtration.

Base catalysts which have been utilised include, but are not limited to, alkali metal hydroxides such as potassium or caesium hydroxide, alkali metal alkoxides or complexes of alkali metal hydroxides and an alcohol, alkali metal silanolates such as potassium silanolates prepared with siloxane oligomers or trimethylpotassium silanolate, phosphazene bases and the catalyst derived by the reaction of a tetra-alkyl ammonium hydroxide and a siloxane tetramer as described in U.S. Pat. No. 3,433,765.

Acid catalysts are used in some situations when preferred to base catalysts. For example, acid catalysts are typically used for polymers with Si—H functionality because the base catalysts tend to degrade polymers containing Si—H groups. Acid catalysts are also utilised in the preparation of lower viscosity and commodity (trimethyl endcapped) polymers.

Although many of these catalysts (both base catalysts and acid catalysts) are highly active, they tend to produce large quantities (i.e., greater than (>) 10 wt. % (100,000 ppm) of cyclic by-products), most often octamethylcyclotetrasiloxane, through the equilibrium reaction which occurs during the ring-opening polymerisation process.

There is a desire in the industry to reduce the reliance on cyclosiloxane oligomers having an average of about 4 siloxane units in processes for the preparation of siloxane polymers from cyclosiloxane ring starting ingredients and to reduce the generation of cyclosiloxane oligomers having an average of about 4 to 5 siloxane units as by-products from processes for the preparation of siloxane polymers from cyclosiloxane ring starting ingredients through equilibrium reactions.

There is provided herein a base catalysed process for the preparation of linear or branched siloxane polymers and copolymers, by the ring-opening polymerisation of macrocyclic cyclosiloxane oligomers having from 7 to 10

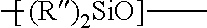

units per molecule, wherein each R″ group per unit is the same or different and is an alkyl group having from 1 to 6 carbons; which base catalysed process comprises the steps of
   (a) introducing
      (i) said macrocyclic cyclosiloxane oligomers in an amount of from 50 to 99 wt. % of the starting ingredients with
      (ii) one or more end-blockers in an amount of from 1 to 50 wt. % of the starting ingredients and optionally
      (iii) a co-monomer selected from a linear organosiloxane co-monomer, a branched organosiloxane co-monomer or cyclosiloxane co-monomer wherein said cyclosiloxane co-monomer has from 3 to 10 —[(R⁸)(R⁹)SiO]—
         units per molecule, wherein each R⁸ group is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸;
      said co-monomer (iii), when present, being present in an amount of from 1 to 50 wt. % of the starting ingredients;
into a mixing vessel and mixing;
   (b) optionally introducing an organic solvent in an amount of up to 7.5 wt. % of the starting ingredients into the mixing vessel during or subsequent to step (a);
   (c) heating said starting ingredient (i) to a predetermined reaction temperature of from 25 to 160° C. in an inert atmosphere before introducing component (ii) and optionally component (iii), when present, or
      heating a mixture of starting ingredients (i), (ii) and optionally (iii) to a predetermined reaction temperature of from 25 to 160° C. in an inert atmosphere;
   (d) once the predetermined reaction temperature has been reached, and starting materials (i), (ii) and optionally (iii) are thoroughly mixed together, introducing a final starting ingredient, a base catalyst (iv) in an amount of from 0.001 to 10 wt. % % of the starting ingredients; thereby forming an initial reaction mixture;
   (e) agitating the initial reaction mixture at the predetermined reaction temperature for up to 24 hours until a step (c) product, within a desired number average molecular weight range and/or a cyclics equilibration, is obtained;
   (f) quenching the reaction after step (e) by either filtering off heterogeneous acid catalysts when used or by neutralising the step (e) product with a suitable acid to form a neutralised step (f) product;
   (g) Cooling the step (f) product to ambient temperature to form a cooled step (g) product and optionally,
   (h) Stripping volatile cyclosiloxanes the cooled step (f) product to give a final linear or branched siloxane polymer or copolymer.

The total amount of the complete reaction mixture resulting in step (d) is 100 wt. % of the starting ingredients.

There is also provided a use of a base catalyst in the preparation of linear or branched siloxane polymers and copolymers, by the ring-opening polymerisation of macrocyclic cyclosiloxane oligomers having from 7 to 10

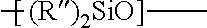

units per molecule, wherein each R″ group per unit is the same or different and is an alkyl group having from 1 to 6 carbons in accordance with the process described herein.

There is also provided a linear or branched siloxane polymer and/or copolymer obtained or obtainable from the process described herein.

### Macrocyclic Cyclosiloxane Oligomer Starting Materials (i)

The macrocyclic cyclosiloxane oligomer starting materials (i) are deemed to be “macrocyclic” because they have at least six, specifically here, from 7 to 10 siloxane units of the structure:

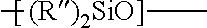

per cyclosiloxane oligomer as opposed to the standard four or five. However, each R″ group per unit is the same or different and is an alkyl group having from 1 to 6 carbons. Hence said cyclosiloxane oligomers may, for example, comprise dimethylsiloxane units, methylethyl siloxane units, diethylsiloxane units, methylpropyl siloxane units, dipropylsiloxane units and/or or tertiary butylmethyl siloxane units (tertiary butyl is hereafter referred to as ^{t}butyl). In one embodiment all the siloxane units in each molecule are the same. In another embodiment at least one R″ group per unit is a methyl or ethyl group, alternatively a methyl group. Hence, the macrocyclic cyclosiloxane oligomer starting materials (i) may comprise, for the sake of example oligomers of the structure [(CH₃)₂)SiO]ₙ—, [(C₂H₅)₂)SiO]ₙ—, [(C₃H₇)₂)SiO]ₙ—, [(CH₃)(C₂H₅)SiO]ₙ— and/or [(CH₃)(C₃H₇)SiO]ₙ— where n″ is from 7 to 10. Specific examples of such macrocyclic cyclosiloxane oligomers include but are not limited to:
tetradecamethylcycloheptasiloxane ([(CH₃)₂)SiO]₇),
hexadecamethylcyclooctasiloxane ([(CH₃)₂)SiO]₈),
octadecamethylcyclononasiloxane ([(CH₃)₂)SiO]₉),
icosamethylcyclodecasiloxane ([(CH₃)₂)SiO]₁₀),
tetradecaethylcycloheptasiloxane ([(C₂H₅)₂)SiO]₇),
hexadecaethylcyclooctasiloxane ([(C₂H₅)₂)SiO]₈),
octadecaethyllcyclononasiloxane ([(C₂H₅)₂)SiO]₉),
icosaethylcyclodecasiloxane ([(C₂H₅)₂)SiO]₁₀),
tetradecapropylcycloheptasiloxane ([(C₃H₇)₂)SiO]₇),
hexadecapropylcyclooctasiloxane ([(C₃H₇)₂)SiO]₈),
octadecapropylcyclononasiloxane ([(C₃H₇)₂)SiO]₉),
icosapropylcyclodecasiloxane ([(C₃H₇)₂)SiO]₁₀),
cyclohepta(methylethyl)siloxane ([(CH₃)(C₂H₅)SiO]₇),
cycloocta(methylethyl)siloxane ([(CH₃)(C₂H₅)SiO]₈),
cyclonona(methylethyl)siloxane ([(CH₃)(C₂H₅)SiO]₉),
cyclodeca(methylethyl)siloxane ([(CH₃)(C₂H₅)SiO]₁₀),
cyclohepta(methylpropyl)siloxane ([(CH₃)(C₃H₇)SiO]₇),
cycloocta(methylpropyl)siloxane ([(CH₃)(C₃H₇)SiO]₈),
cyclonona(methylpropyl)siloxane ([(CH₃)(C₃H₇)SiO]₉) or
cyclodeca(methylpropyl)siloxane ([(CH₃)(C₃H₇)SiO]₁₀),
and mixtures thereof.

Of the above rings having seven siloxane units are preferred e.g., tetradecamethylcycloheptasiloxane, tetradecaethylcycloheptasiloxane, tetradecapropylcycloheptasiloxane, cyclohepta(methylethyl)siloxane, cyclohepta(methylpropyl)siloxane and mixtures thereof. The macrocyclic cyclosiloxane oligomer starting materials (i) may also comprise mixtures of one or more of the above and dodecamethylcyclohexasiloxane. The macrocyclic cyclosiloxane oligomer starting materials are present in the starting composition in an amount of from 50 to 99 wt. % of the starting ingredients, alternatively from 70 to 99 wt. %, alternatively from 75 to 99 wt. %, alternatively from 85 to 99 wt. %.

### End-Blockers (ii)

The one or more end-blockers (ii) are present in an amount of from 0.75 to 50 wt. % of the starting ingredients, alternatively from 0.75 to 25 wt. % of the starting ingredients,

alternatively, from 0.75 to 15 wt. % of the starting ingredients, alternatively from 1.0 to 10 wt. % of the starting ingredients.

They are utilised in order to regulate the molecular weight of the polymer and/or to add terminal functionality. End-blocking agents (end-blockers) are a means of controlling the reactivity/polymer chain length of the polymer and as a means of introducing functionality to the resulting polymer. The end-blocking agent (end-blocker) halts the polymerization reaction and thereby limits the average molecular weight of the resulting polymer. Any suitable end-blocking agent (end-blocker) known to those skilled in the art may be utilised and typically will be chosen with the end use of the polymer in mind.

Suitable end-blocking agents (end-blockers) include functionally terminated polysiloxanes having a degree of polymerisation of from 2 to 2500, for example, functionally terminated short chain (e.g., from a degree of polymerisation of from 2 to 30 Silicon atoms) polysiloxanes or disiloxanes such as alkenyl dialkyl-terminated polydimethylsiloxanes; polydimethylsiloxanes (having from 2 to 2000 silicon atoms in the polymer backbone) dialkylsilanol-terminated or dialkylalkenyl-terminated, e.g., dialkylvinyl-terminated or dialkylhexenyl-terminated. The functional termination mentioned above preferably involves the inclusion of at least one alkenyl group per molecule, for example vinyl and hexenyl groups.

They may also include trialkyl-terminated polydimethylsiloxanes as well as mixtures of any of the above. Other potential end-blockers include silanes, e.g., alkoxy functional silanes and silanols such as trimethylsilanol, trimethylmethoxysilane, and/or methyltrimethoxysilane. Specific suitable end-blockers for the present process include but are not limited to dimethylalkenyl-terminated polydimethylsiloxanes having a degree of polymerisation of from 10 to 350 such as dimethyl vinyl-terminated polydimethylsiloxanes having a degree of polymerisation of from 10 to 100 and dimethylhexenyl-terminated polydimethylsiloxanes having a degree of polymerisation of from 100 to 350, as well as trialkyl terminated polydimethylsiloxanes, usually trimethyl-terminated polydimethylsiloxanes having a viscosity of from 15 to 200 mPa·s at 25° C. such as XIAMETER™ PMX-200 Silicone Fluid 20 cSt, a trimethyl-terminated polydimethylsiloxane having a viscosity of 20 cSt at 25° C., commercially available from Dow Silicones Corporation of Midland, Michigan USA. The end-blockers may also comprise one or more disiloxanes such as hexamethyldisiloxane, 1,1,3,3-tetramethyldisiloxane, and 1,3-divinyltetramethyldisiloxane. However, preferably the end-blockers comprise at least one alkenyl group having from two to 6 carbons, typically a vinyl group or a hexenyl group.

Co-Monomers (iii)

Co-monomers (iii) are optionally present. When present, co-monomer (iii) may comprise a co-monomer selected from a linear organosiloxane co-monomer, a branched organosiloxane co-monomer or cyclosiloxane co-monomer wherein said cyclosiloxane co-monomer has from 3 to 10

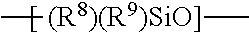

units per molecule, wherein each R⁸ group is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸. When present the co-monomer (iii), is present in an amount of from 1 to 50 wt. % of the starting ingredients.

Co-monomer (iii) may comprise one or more cyclosiloxanes having from 3 to 10

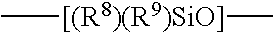

units per molecule, wherein each R⁸ group per is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸. The cyclic co-monomers may include for the sake of example methylvinylsiloxane units, trifluoroalkylmethylsiloxane units, e.g., trifluoropropylmethylsiloxane units and/or phenylmethylsiloxane units in the ring. The cyclic co-monomers may for example include but are not limited to one or more of the following:
[(CH₃)(CH═CH₂)SiO]_{n′}, (CH₃)((CH₂)₄CH═CH₂)SiO]_{n′}, [(CH₃)(Ph)SiO]_{n′} (where Ph=phenyl), ([(Ph)₂SiO]_{n′}, [(CF₃(CH₂)₂)(CH₃)SiO]_{n′}, [(CH₃)(NH₂)SiO]_{n′} and/or [(CH₃)(—(CH₂)₃NH(CH₂)₂NH₂)SiO]_{n′}; where n′ is from 3 to 10, alternatively from 6 to 10, alternatively from 7 to 10, and mixtures comprising at least one of the above. Whilst the number of siloxane groups in cyclic co-monomers can be from 3 to 10, in a preferred embodiment said co-monomers are macrocyclic cyclosiloxane oligomers having from 7 to 10 siloxane units. Of the above ring structures, cyclic siloxanes having seven siloxane units are particularly preferred e.g., tetradecamethylcycloheptasiloxane, cyclohepta(methylvinyl)siloxane, cyclohepta(phenylmethyl)siloxane and cyclohepta(trifluoropropylmethyl)siloxane.

Alternatively, or additionally, when present, co-monomer (iii) may comprise or consist of a trialkyl-silyl-terminated linear or a trialkyl silyl-terminated branched organopolysiloxane. The trialkyl silyl-terminated linear or a trialkyl silyl-terminated branched organopolysiloxane may comprise multiple units of the structure:

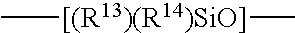

units per molecule, wherein each R¹³ group per siloxane unit is the same or different and is selected from an alkenyl group, an alkynyl group, an aryl group, a fluoroalkyl such as trifluoropropyl or a perfluoroalkyl group or a primary or secondary amine groups or alkylethylenediamine groups and each R¹⁴ group is selected from an alkyl group having from 1 to 6 carbons or R¹³.

The linear organopolysiloxane co-monomer and branched organopolysiloxane co-monomer may comprise dialkylsilanol-terminated polydiorganosiloxanes having alkenyl containing and/or amine containing side chains. The alkenyl containing side chains may contain from 2 to 10 carbons, e.g., vinyl groups, propenyl groups, n-butenyl groups, n-pentenyl groups and n-hexenyl groups. The amine containing side chains may comprise primary or secondary amines or alkyl ethylenediamine groups wherein the alkyls have 2 to 10 carbons, alternatively, 2 to 7 carbons, alternatively 3 to 6 carbons, such as, for the sake of example groups such as —(CH₂)₃NH(CH₂)₂NH₂, —(CH₂)₂NH(CH₂)₂NH₂, —CH₂CH(CH₃)CH₂NH(CH₂)₂NH₂ and —(CH₂)₄NH(CH₂)₂NH₂ or mixtures thereof.

Surprisingly, it was found co-monomers (iii), including both cyclosiloxane and hydrolysate co-monomers, can be easily incorporated at relatively low levels (less than (<) 10 wt. %) under milder reaction conditions, in particular at lower temperatures at which polymerisation of the macrocyclic cyclosiloxane oligomers (i), especially macrocyclic cyclosiloxane oligomers having seven siloxane units per ring proceeds.

Co-monomer (iii), when present, is present in an amount of from 1 to 50 wt. % of the starting ingredients alternatively from 1 to 25 wt. % of the starting materials, alternatively from 1 to 15 wt. % of the starting materials, alternatively from 1 to 10 wt. % of the starting materials. Co-monomers (iii) can be incorporated into the mixture in several ways. For example, they can be equilibrated in from homopolymers of the co-monomer or added as reactive monomers. Hydrolysate co-monomers may be functional cyclosiloxane cyclics hydrolysate (a mixture of cyclosiloxanes and silanol-terminated homopolymer), or a functional homopolymer.

### Organic Solvent

As indicated an optional organic solvent may be introduced in accordance with step (b) if desired. The organic solvent concerned may be, for example, a linear, branched or cyclic aliphatic hydrocarbon which may optionally be chlorinated; linear, branched or cyclic ethers or aromatic solvents. For example, the organic solvents may be aprotic organic solvents, such as tetrahydrofuran, toluene, or dichloromethane. The organic solvent, when present, is different from the cyclic oligomer (i), end-blocker (ii) and co-monomer (iii) starting ingredients described above. When present the organic solvent, may be used to deliver one or more of the other starting materials. For example, a starting material such as the catalyst may be dissolved in an organic solvent before combining with the other ingredients. The organic solvent may be used to deliver one or more starting materials e.g., said catalyst and then the reaction may proceed in organic solvent. The amount of organic solvent depends on various factors including the type and amount of the other starting materials selected and on whether one or more starting materials is/are being delivered in an organic solvent, or whether the reaction will proceed in an organic solvent.

Whilst an organic solvent may be incorporated into the composition in optional step (b), it is not usually preferred as it can be advantageous, if possible, to undertake the polymerisation neat i.e., in the absence of organic solvent. When an organic solvent is present step (b) may involve introducing said organic solvent in an amount of up to 7.5 wt. % of the starting ingredients into the mixing vessel during or subsequent to step (a), the organic solvent concerned is typically an organic solvent such as linear, branched or cyclic aliphatic hydrocarbon which may optionally be chlorinated, linear, branched or cyclic ethers or aromatic solvents. For example, the organic solvents may be aprotic solvents, such as tetrahydrofuran, toluene, or dichloromethane. The organic solvent, when present, is different from the cyclic oligomer (i), end-blocker (ii) and co-monomer (iii) starting ingredients described above. However, preferably no organic solvent is introduced into the mixing vessel during or subsequent to step (a) and as such the process has then been undertaken “neat”.

### Base Catalyst (iv)

Once the predetermined reaction temperature has been reached at the end of step (c), in step (d), a final starting ingredient, a base catalyst (iv), is introduced into the composition to form the complete reaction mixture. The catalyst is any suitable base catalyst for example:
(I) an alkali metal hydroxide, such as lithium hydroxide, sodium hydroxide, potassium hydroxide, cesium hydroxide or rubidium hydroxide, alternatively from, sodium hydroxide, potassium hydroxide, cesium hydroxide or rubidium hydroxide, alternatively sodium hydroxide or potassium hydroxide;
(II) alkali metal alkoxides or complexes of alkali metal hydroxides and an alcohol wherein the alkali metal is lithium, sodium, potassium, caesium or rubidium; alternatively, wherein the alkali metal is sodium, potassium, caesium or rubidium;
(III) an alkali metal trialkyl silanolate

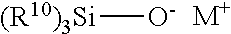

wherein each R¹⁰ group may be the same or different and is an alkyl group having from 1 to 6 carbons and M is an alkali metal group such as lithium, sodium, potassium cesium and rubidium, alternatively an alkali metal group selected from sodium, potassium cesium and rubidium. Preferably each R¹⁰ group is the same and comprises 1 to 4 carbons, alternatively 1 or 2 carbons, alternatively is a methyl group; in one embodiment M is potassium.
(IV) A polymeric or oligomeric silanolate of the structure

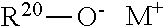

where M is as described above and R²⁰ is an organopolysiloxane chain, wherein the organopolysiloxane chain R²⁰ may have the structure

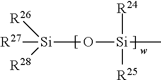

In which each R²⁴ may be the same of different and comprises an alkyl group having from 1 to 10 carbons, alternatively from 1 to 6 carbons, alternatively from 1 to 4 carbons, alternatively is a methyl or ethyl group, said alkyl group may be a substituted alkyl group containing e.g. chloro substituted alkyl groups; each R²⁵ may be the same or different and may be R²⁴ or an alkenyl group having from 2 to 10 carbons alternatively from 2 to 6 carbons, alternatively a vinyl group or a hexenyl group, an alkynyl group having from 2 to 10 carbons, a alternatively from 2 to 6 carbons, alternatively from 2 to 4 carbons alternatively an ethynyl group; an aromatic group, such as a phenyl group or an alkoxy group having from 1 to 10 carbons, alternatively from 1 to 6 carbons, alternatively from 1 to 4 carbons.

Each of R²⁶, R²⁷ and R²⁸ may be the same or different and may be a hydroxyl group or R²⁵. Each w is an integer of from 2 and 200 alternatively from 2 and 150, alternatively from 2 and 125, alternatively from 2 to 100, alternatively from 2 to 75 when introduced into the composition as starting ingredient (iv).

The R²⁰—O⁻ M⁺ may dimerize and as such the alkali metal silanolate base catalyst (iv) may be at least partially in a dimeric form.

In one example, the alkali metal silanolate base catalyst (iv) may be a trifluoropropylmethyl silanolate which has the following structure:

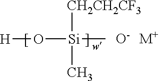

where M is as previously defined, for example potassium or sodium and the initial average value of w′ is between 2 and 75 when added into the mixture of other starting ingredients in step (d);
   (V) Non-metallic silanolates such as silanolates of the alkylammonium hydroxide compounds, for example: tetramethylammonium trimethylsilanolate [(CH₃)₄N—OSi(CH₃)₃], tetraethylammonium trimethylsilanolate, tetrapropylammonium trimethylsilanolate, tetramethylammonium triethylsilanolate, tetraethylammonium triethylsilanolate, tetrapropylammonium triethylsilanolate, tetramethylammonium tripropylsilanolate, tetraethylammonium tripropylsilanolate, tetrapropylammonium tripropylsilanolate, and the like; or
   (VI) phosphazene bases, or
   (VII) a suitable alkoxide, e.g., a metal alkoxide such as an alkali earth alkoxide or organic alkoxide; or
   (VIII) ammonia.

In one embodiment the catalyst may be selected from any of catalyst types (I), (II), (III) (IV) or (VII) above, particularly where M is sodium or potassium, alternatively potassium.

The base catalyst (iv) may be introduced into the mixture dissolved in or suspended in one of the other staring ingredients (i), (ii) or (iii) when the latter is present or an alternative cyclosiloxane, alternatively in component (i).

The base catalyst (iv) may be present in the amount of from 0.001 wt. % to 10 wt. % of the starting ingredients, alternatively 0.01 wt. % to 5 wt. %.

In the process described herein, macrocyclic cyclosiloxane oligomers (i) and co-monomer(s) (iii) when present are preferably, introduced into the mixing vessel dry. They may be dried by any suitable process, such as, for example, drying over molecular sieves or the like or by distillation and nitrogen stripping.

The mixing vessel may be any suitable type of mixing vessel for example a batch mixer or a continuous plug flow type reactor (given the speed of reaction) comprising a series of stacked vessels with a central agitator with the flow being top-down (i.e., the reactor is positioned vertical and the reaction mixture is introduced into the mixer at the top of the mixer) and the viscosity of the polymer produced increases as it moves down through and subsequently out of the reactor. Historically, the ring opening polymerisation of oligomers having four siloxane units per ring (e.g., octamethylcyclotetrasiloxane) is carried out at a temperature of at least 160° C. In step (c) of the process herein, however, whilst the mixing vessel, e.g., batch reactor or continuous plug-flow type reactor may be heated to a pre-determined reaction temperature as high as 160° C. if desired, this would appear unnecessary unless specifically desired to complete the reaction exceptionally quickly and preferably the pre-determined reaction temperature for the base catalysed ring-opening polymerisation of macrocyclic cyclosiloxane oligomers described herein can be from greater than (>) 25° C. to 160° C. but advantageously can be from >25° C. to 150° C., alternatively from >25° C. to 125° C., alternatively from >25° C. to 100° C. alternatively from 40° C. to 100° C. alternatively from 50° C. to 100° C. as the resulting ring-opening polymerisation process benefits from undertaking polymerisation at much lower temperatures if desired. The reaction is undertaken in an inert atmosphere, i.e., under nitrogen and/or argon, alternatively under nitrogen.

Once the initial reaction mixture has reached the desired temperature in step (c) base catalyst (iv) is added to form the complete reaction mixture in step (d). Subsequent to the addition of base catalyst (iv) the ring-opening polymerisation reaction takes place in step (e). The contents of the reaction vessel during step (e) are agitated in any suitable way e.g., by stirring the contents of the reaction vessel, by shaking or sonicating or the like the reaction vessel itself throughout the reaction process step (e) for up to 24 hours.

### Neutralising Agent

Any suitable neutralising agent may be used in step (f) to quench the reaction after step (e) and to form a step (f) product. These may include for the sake of example mild acids e.g., mild Lewis acids effective for neutralizing the base catalyst (iv). Such neutralizing agents can be selected from, for example, acetic acid, phosphoric acid, trimethylsilylated phosphoric acid, tris(chloroethyl)phosphite silyl phosphate, polyacrylic acid, chlorine substituted silanes, carbon dioxide, and suitable buffers such as mono sodium phosphate (NaH₂PO₄), or disodium phosphate (Na₂HPO₄) or another suitable acidic neutralising agent to deactivate the base catalyst (iv). One neutralising agent which may be utilised is the weak Lewis acid carbon dioxide which functions when used in conjunction with silanolate catalysts. For example, when the base catalyst (iv) used is a sodium trialkyl silanolate the neutralising agent will typically react with the sodium trialkyl silanolate to form sodium bicarbonate salt end groups and other sodium salts. Other neutralizing agents such as silyl phosphonates, a silylated phosphoric acid such as trimethylsilylated phosphoric acid and octyl silyl phosphonate optionally provided in a suitable solvent) and fumed silica may be utilised alone or in combination with the silanols.

When the polymer produced is via a batch process any suitable neutralising agent may be utilised. However, when the polymer is produced in a continuous reactor as described above, the neutralising agent may be selected dependent on the product being prepared, for example, low viscosity polymers, e.g., about 100,000 mPa·s or less, at 25° C. can be neutralised with such neutralising agent silyl phosphate and higher viscosity polymers, e.g., greater than (>) about 100,000 mPa·s at 25° C. may be neutralised with CO₂. Any suitable method to measure viscosity may be utilised for example viscosity may be measured using a Brookfield cone and plate Viscometer such as a Brookfield LVDV-E viscometer.

Once quenching e.g. neutralisation has been completed in said step (f), the reaction mixture is cooled to ambient temperature in step (g) to form a step (g) product which is the final linear or branched siloxane polymer or copolymer and which is then typically removed from the reaction vessel, e.g., batch reactor and collected or optionally undergoes stripping step (h) to remove remaining volatile materials from the step (g) product to give the final linear or branched siloxane polymer or copolymer.

Optional step (h), the stripping of the step (g) product, may be undertaken using any suitable means, for example using a wiped film evaporator (WFE).

If desired the resulting final linear or branched siloxane polymer or copolymer maybe evaluated for molecular weight, cyclosiloxane content, cyclosiloxane makeup, and optionally non-volatile content subsequent to completion of the process.

Hence, in one embodiment, i.e., when the intention is to make linear polydimethylsiloxane via the ring opening polymerisation of macrocyclic cyclosiloxane oligomers having between 7 and 10 siloxane units per cyclic ring, particularly macrocyclic cyclosiloxane oligomers having 7 siloxane units per cyclic ring the process may be as follows:
Introducing starting ingredient (i) into a polymerisation reaction and heating same to a predetermined reaction temperature before introducing starting ingredient (ii) and optionally (iii) mixing together at the reaction temperature; or
Introducing starting ingredients (i) and (ii) and optionally (iii) into a polymerisation reaction and heating same to a predetermined reaction temperature;
Introducing base catalyst (iv) into the mixture resulting from either of the above;
Reacting the starting ingredients for a predetermined period of time and then neutralising the mixture with a suitable neutralising agent; such as silyl phosphate for low viscosity polymers or CO₂ for high viscosity polymers;
Cooling the neutralised reaction product and optionally stripping off residual volatiles from the reaction product.

The reaction may be undertaken after the catalyst is introduced by feeding the reaction mixture into a plug flow type reactor having a series of stacked vessels with a central agitator, with the reaction mixture flow being top-down and the viscosity of the polymer being produced increasing with residence time as it moves down and subsequently out of the reactor with neutralization taking place after exit from the plug flow type reactor.

As discussed elsewhere neutralization may be with silyl phosphate for low viscosity polymers or CO₂ for high viscosity polymers.

Although optionally it will be preferred to strip the polymer product resulting from the above process of volatiles. This may be completed using a suitable wiped film evaporator as discussed herein.

Typically, the reaction temperature is between 4° and 150° C., alternatively between 5° and 125° C., alternatively between 6° and 125° C., alternatively between 6° and 110° C.

The WFE is designed to continuously strip out volatile compounds by mechanically vibrating a thin film, in this case, the final linear or branched siloxane polymer or copolymer on a heated surface at a temperature, in a range of from 20° C. to 210° C. A major difference is the need to heat the polymer post neutralization for the wiped film evaporator (sometimes referred as a WFE). Also, a smaller WFE could be used due to the lower level of cyclics needed for removal in the finished polymer. Alternatively, optional step (h) may be undertaken using an aluminum pan with a heating element placed over it, again at a temperature, in this case, in a range of from 20° C. to 210° C.

It will be appreciated that this alternative process is performed neat, i.e., negating the need for removal of organic solvent after the polymerization process is complete. Furthermore, the presence of endblocker in this system allows for precise control over the molecular weight and properties of the resulting materials.

### Final Linear or Branched Siloxane Polymer or Copolymer

The process described herein produces a final linear or branched siloxane polymer or copolymer, which can be of any appropriate molecular weight and/or degree of polymerisation. For example, the number average molecular weight (Mn) or weight average molecular weight (Mw) may be at least 2500 Da, alternatively at least 5000 Da i.e., in a range of from 5000 Da to 100,000 Da, alternatively when Mn has reached a value of from 5000 Da to 30,000 Da as determined by size exclusion chromatography using the method described in the examples.

Typically, the degree of polymerisation of the final linear or branched siloxane polymer or copolymer, produced via the process herein may be of any desired suitable chain length. It may be as short as 10 but is typically greater than (>) 50, alternatively >100, alternatively >300, alternatively >400, alternatively >500, alternatively >1000, alternatively >1500, and alternatively >2000.

Furthermore, advantageously the resulting product has a low octamethylcyclotetrasiloxane content e.g., less than (<) 10 wt. % (100,000 ppm), alternatively <8 wt. % (80,000 ppm), alternatively <7 wt. % (70,000 ppm).

As previously indicated, contrary to the disclosure herein, the cyclosiloxane oligomers used as polymer building blocks typically have an average of from 3 to 5 siloxane units in each cyclosiloxane ring. Usually, but not always, the cyclosiloxane oligomers have an average of about 4 siloxane in each cyclosiloxane ring units (i.e., octamethylcyclotetrasiloxane). This is typically because oligomers having four siloxane groups per ring, especially octamethylcyclotetrasiloxane are, probably the most abundant cyclosiloxane feedstock and are often found to be the purest of the distilled cyclosiloxanes. Surprisingly, however, it has now been determined that macrocyclic cyclosiloxane oligomer starting materials (i) as described herein, especially those having seven siloxane units per ring (e.g., tetradecamethylcycloheptasiloxane) may be polymerized using base catalysis at a faster rate than cyclosiloxane oligomers having an average of 3 to 5 siloxane units, particularly octamethylcyclotetrasiloxane, under the same reaction conditions. Consequently, the macrocyclic cyclosiloxane oligomer starting materials (i) as described herein, can undergo polymerisation under milder conditions or can be used to polymerize at rates at or far exceeding the rate of polymerization of cyclosiloxane oligomers which have an average of from 3 to 5 siloxane units per molecule, which will allow for increased production volume, or the ability to run the reactions at lower temperatures. Advantageously, running these polymerizations at lower temperatures tend to result in the generation of polymer products with lower levels of cyclosiloxane by-products post reaction (ca. 1 wt. %) vs the typical 13 wt. %.

A further advantage using the process herein is that these materials may be polymerized in bulk reactions with e.g., an alkenyl endblocker negating the need to use organic solvents or additional reagents, unless specifically desired or required.

Whilst this process is largely directed to the generation of polymers, even with large amounts of co-monomers (iii) present in the complete reaction mixture it was found that polymers were easily prepared in the presence of macrocyclic cyclosiloxane oligomer starting materials (i), especially those having seven siloxane units per ring (e.g., tetradecamethylcycloheptasiloxane). This was considered quite surprising as it was anticipated that the resulting polymers would be likely to polymerise into a dimethylsiloxane homopolymer form and fail to incorporate components (ii) and (iii) into the polymer produced.

Furthermore, if desired, resulting final linear or branched siloxane polymer or copolymers produced by the process herein may contain pendant functionality as a result of base catalysis with such enhanced kinetics.

Unexpectedly, it has been identified that macrocyclic cyclosiloxane oligomer starting materials (i) having seven siloxane units per ring (e.g., tetradecamethylcycloheptasiloxane) seem to be the most efficiently polymerised, contrary to initial expectations, anticipating the reaction kinetics increasing with increasing ring size of the macrocyclic cyclosiloxanes. Indeed, it was found that the macrocyclic cyclosiloxane oligomer starting materials (i) having seven siloxane units per ring polymerized under base catalysis with enhanced kinetics can incorporate pendant functionality via an equilibration reaction pathway with hydrolysate co-monomers (iii).

Ring opening polymerisation (ROP) of these siloxanes proceeds via an equilibration polymerisation reaction pathway which results in polymer preparation in conjunction with the production of cyclic oligomer equilibrium by-products (especially octamethylcyclotetrasiloxane). However, it has unexpectedly been identified that the base catalysed polymerisation process described herein produces much lower levels of the cyclic oligomers such as octamethylcyclotetrasiloxane as by-products of the equilibration polymerisation process. When polymerizing a single monomer type, it was also determined that using macrocyclic cyclosiloxane oligomers having seven siloxane units per ring as component (i) was preferred to using cyclosiloxane oligomers having six, eight, nine and ten siloxane units per ring as the former produced less cyclic by-products during the polymerisation process described herein.

Whilst it is advantageous to use said macrocyclic cyclosiloxane oligomers as component (i) because they have been identified as being polymerisable at much lower temperatures than the current standard siloxane oligomers having three to five siloxane units per ring oligomers, particularly octamethylcyclotetrasiloxane oligomers, the use of said macrocyclic cyclosiloxane oligomers as component (i) has the significant advantage that even with the milder reaction conditions (low reaction temperatures) both end-blockers (ii), preferably end-blockers containing at least one alkenyl end-blocker as described herein, and co-monomers (iii) are readily incorporated into the resulting polymer if desired. This advantageous effect does not appear to have been appreciated in the prior art. Indeed, it was identified that even with large amounts of co-monomer (iii) present polymer could be readily made using macrocyclic cyclosiloxane oligomers as component (i) i.e., tetradecamethylcycloheptasiloxane.

The polymers resulting from the polymerisation of macrocyclic cyclosiloxane oligomers as described herein may be utilised as the siloxane polymer ingredient in any composition utilising siloxane polymers. For example, a standard siloxane polymer used the preparation of liquid silicone rubber compositions or condensation cure sealants and adhesives may be replaced by an equivalent siloxane polymer as made by the process described herein.

### EXAMPLES

These examples are intended to illustrate some embodiments of the disclosure and should not be interpreted as limiting the scope set forth in the claims.

the following ingredients are referred to in Table 1 in respect to examples Ex. 1 to 7 and Comparatives C. 1 to 3.

### Cyclosiloxane Oligomers (Cyclics Dx)

D4 was octamethylcyclotetrasiloxane supplied 98% pure from MiliporeSigma of Burlington Massachusetts USA;
D5 was decamethyl cyclopentasiloxane supplied 97% pure from MiliporeSigma of Burlington Massachusetts USA;
D6 was dodecamethyl cyclohexasiloxane from Gelest Inc. of Morrisville, Pennsylvania USA;
D7 was tetradecamethyl cycloheptasiloxane supplied 95% pure from Gelest Inc. of Morrisville, Pennsylvania USA;
D8⁺ was a mixture of hexadecamethylcyclooctasiloxane, octadecamethylcyclononasiloxane, and icosamethylcyclodecasiloxane.

### End-Blockers

Vinyl end-blocker: dimethylvinyl-terminated polydimethylsiloxane having an average degree of polymerization of 20;
Hexenyl end-blocker: dimethylhexenyl polydimethylsiloxane having an average degree of polymerization of 200;
PDMS: was XIAMETER™ PMX-200 Silicone Fluid 20 cSt, a trimethyl-terminated polydimethylsiloxane having a viscosity of 20 cSt at 25° C., commercially available from Dow Silicones Corporation of Midland, Michigan USA.

### Co-Monomers

“Amine” comonomer: the “amine” co-monomer used in the following examples had the following structure with an average degree of polymerisation of about 14.6.

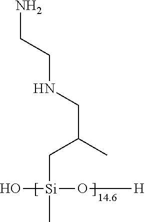

V4 co-monomer: 2,4,6,8-Tetramethyl-2,4,6,8-tetravinylcyclotetrasiloxane
5-Hex Co-monomer: a mixture of methylhexenyl-cyclosiloxane oligomers and silanol terminated methyl/hexenyl homopolymer with an average degree of polymerisation of 14.6;
Vinyl co-monomer: dimethylvinyl-terminated polydimethylsiloxane having an average degree of polymerisation of 20.

### Base Catalyst

Trimethyl potassium silanolate, made internally—where the silanolate was a polydimethylsiloxane with a degree of polymerization of about 60. All above parameter values and purity levels are taken from supplier data.

TABLE 1
Starting ingredients used for Examples
1 to 7 and comparative examples 1 to 4.

| | | | | | Ratio of |
|---|---|---|---|---|---|
| | Cyclic | target | End- | Co- | cyclic:co-monomer:end- |
| | Dx | DP | blocker | monomer | blocker (wt./wt./wt.) |
| C. 1 | 4 | 900 | vinyl | no | 97:0:3 |
| C. 2 | 6 | 450 | vinyl | no | 93.5:0:6.5 |
| C. 3 | 6 | 900 | vinyl | no | 97:0:3 |
| Ex. 1 | 7 | 816 | hexenyl | no | 75:0:25 |
| Ex. 2 | 7 | 920 | vinyl | no | 97.5:0:2.5 |
| Ex. 3 | 7 | 320 | PDMS | amino | 90:4.5:5.5 |
| Ex. 4 | 7 | 347 | PDMS | hexenyl | 91:6.5:2.5 |
| Ex. 5 | 7 | 390 | vinyl | vinyl | 87:7:6 |
| Ex. 6 | 8 | 450 | PDMS | no | 95:0:5 |
| Ex. 7 | 8 | 900 | vinyl | no | 97:0:3 |

Polymerisation processes were undertaken for the starting ingredients identified in Table 1 above for C. 1 to 3 and Ex. 1 and 3 to 6 using the following process:

To a 40 mL vial was added a cyclosiloxane and an endblocker. These starting materials were then mixed whilst the mixture was heated to the desired temperature (see Table 2 below). Once the desired reaction temperature had been reached, the catalyst (dissolved 10 wt. % in cyclosiloxane oligomer used in the example or comparative example concerned as component (i)) was added. The reaction mixture was then continuously stirred for a period of approximately 4.5 hours. The reaction mixture was then neutralised using a solution of silylated phosphoric acid in decamethylcyclopentasiloxane. In this instance it was considered unnecessary to undertake optional stripping step (h) given this example was undertaken on a small scale. Analysis of the results was undertaken after neutralisation.

Examples 2 and 7 were prepared using a slightly different process.

In Ex. 2, tetradecamethylcycloheptasiloxane (99%, 294.9 g, 795.4 mmol) was weighed out into a polymerization reactor. The tetradecamethylcycloheptasiloxane containing reactor was purged with nitrogen for 20 minutes. A heating mantle was raised under the reactor and the reactor was heated. The reactor headspace was initially swept with nitrogen and then placed under a blanket of nitrogen for the remainder of the reaction.

Once the reactor reached an internal temperature of 70° C., the vinyl endblocker was added (4.07 g, 3.95 mmol). After mixing the end-blocker into the oligomer at the reaction temperature of 70° C., potassium silanolate catalyst dissolved in decamethylcyclopentasiloxane (0.94 g, 10% in decamethylcyclopentasiloxane, 2.59 mmol, 24.5 ppm) was added. The reaction temperature was maintained at 70° C. and stirring continued for the duration of the reaction. After 2 hours, a 2.5 wt. % solution of octyl silyl phosphonate in decamethylcyclopentasiloxane (2.26 g, 9.93 mmol) was added to neutralize the catalyst. After cooling, stirring is stopped, and the polymer is collected once the reaction mixture has completely cooled to room temperature.

The Mw and Mn results in Table 2 below were determined using size exclusion chromatography apart from Ex. 4 which was determined by way of nuclear magnetic resonance (NMR). The amount of cyclics remaining after completion of the ring opening polymerisation process was determined by means of NMR and in the case of C. 2 and C. 3 these were confirmed by volatiles analysis. Further details on the test methods are discussed below.

### Nuclear Magnetic Resonance (NMR):

¹H and ²⁹Si NMR were taken on a Varian 400 MHz spectrometer with a Bruker SampleExpress autosampler and a cryoprobe. ²⁹Si NMR samples were prepared as solutions in CDCl₃ with ~10⁻² M chromium (III) acetoacetonate (Cr(acac)₃) as a spin relaxation agent.

### Size Exclusion Chromatography (SEC or GPC):

GPC samples were prepared as 2 mg/mL samples in toluene and were run on an Agilent™ 1260 GPC with Mixed C or D columns and a refractive index detector. Samples were run with a toluene eluent at a flow rate of 1.00 mL/min at a temperature of 35° C.

Volatiles Analysis: Volatiles analysis was conducted in a Mettler Toledo HB43 moisture analyzer by weighing out ~4 g of polymer and then heating the polymer to 200° C. for 30 minutes and subsequently re-weighing the sample.

The reaction temperatures and results of the polymerisation processes undertaken in accordance with C. 1 to 3 and Ex. 1 to 7 are depicted in Table 2 below.

TABLE 2
Polymerisation Temperatures and Results of Polymerisation
Process for C. 1 to 4 and Ex. 1 to 7

| | Reaction | | | | Wt. % Non-Volatiles in |
|---|---|---|---|---|---|
| | Temp (° C.) | Mn | Mw | PDI | Polymer product |
| C. 1 | 160 | 64090 | 107349 | 1.7 | 85.74 |
| C. 2 | 120 | 37902 | 62650 | 1.7 | 87.58 |
| C. 3 | 120 | 67118 | 117330 | 1.7 | 88.67 |
| Ex. 1 | 70 | 55646 | 97043 | 1.7 | 95.66 |
| Ex. 2 | 70 | 70485 | 130285 | 1.8 | 96.63 |
| Ex. 3 | 70 | 38167 | 43757 | 1.2 | 92.4 |
| Ex. 4 | 70 | 35485 | 57968 | 1.6 | 92.98 |
| Ex. 5 | 70 | 36563 | 60164 | 1.6 | 94.43 |
| Ex. 6 | 70 | 45096 | 84287 | 1.9 | 92.6 |
| Ex. 7 | 100 | 62815 | 107615 | 1.7 | 90.87 |

C. 2 volatiles analysis showed 86% non-volatile content (NVC) and C. 3 volatiles analysis showed 87% NVC.

It can be seen that from the results in Tables 1 and 2, C. 1 depicts the polymerisation of D4 which is the industrial standard cyclosiloxane used for ring-opening polymerisation, without rate enhancement and cyclics reduction. It is to be noted that the chosen reaction temperature was 160° C., significantly greater than the temperature necessary for Ex. 1 to 7. C. 2 and C. 3 indicate that when cyclosiloxane oligomers having six siloxane units per ring (D6) were used in conjunction with potassium silanolate catalyst the rate can be seen to have increased, but the cyclics content wasn't enhanced. This clearly shows that these two factors do not vary automatically in the same way.

In contrast, Ex. 1 to 7 indicate that the reaction rate is enhanced and cyclics can be reduced in cases where the cyclic starting material is carefully selected (i.e., D7, and macrocyclic mixture (D8+)).

In Table 3, the residual cyclics profile using gas chromatography is shown after stripping. The stripping process undertaken used a wiped film evaporator (WFE) at a temperature 200° C. The gas chromatography was undertaken using the following process:

### Gas Chromatography (GC):

GC was taken on an Agilent™ 7890A with a DB5 column and a Gerstel MPS Sampling system. The method consisted of holding at 50° C. for 2 minutes, then ramping temperature to 250° C. at 20° C. min-1 and then hold at 250° C. for 3 minutes.

TABLE 3
the residual cyclics profile is shown after stripping.

| | Cyclic Dx | % D4 | % D5 | % D6 | % D7 | % D8 | % D9 | % D10 |
|---|---|---|---|---|---|---|---|---|
| C. 1 | 4 | 36 | 16 | 12 | 12 | 9 | 5 | 2 |
| C. 2 | 6 | 31 | 18 | 13 | 12 | 9 | 5 | 3 |
| C. 3 | 6 | 30 | 18 | 12 | 11 | 8 | 4 | 2 |
| Ex. 1 | 7 | 8 | 6 | 18 | 26 | 20 | 11 | 5 |
| Ex. 2 | 7 | 16 | 6 | 18 | 20 | 15 | 8 | 4 |
| Ex. 3 | 7 | 14 | 10 | 13 | 28 | 14 | 7 | 3 |
| Ex. 4 | 7 | 13 | 5 | 15 | 28 | 16 | 8 | 4 |
| Ex. 5 | 7 | 15 | 6 | 18 | 22 | 17 | 8 | 4 |
| Ex. 6 | 8 | 16 | 6 | 13 | 18 | 14 | 9 | 7 |
| Ex. 7 | 8 | 19 | 12 | 16 | 18 | 16 | 8 | 4 |

The wt. % of volatiles in Table 3 does not add up to 100 wt. %, this is because the volatiles includes both cyclosiloxane oligomers having three siloxane units per ring and macrocyclic cyclosiloxane oligomer having 11 or more siloxane units per oligomer none of which were determined. This shows that by using cyclosiloxane oligomers having 7 to 10 siloxane units per ring as starting oligomers (i) the amount of residual siloxane rings having four siloxane units per ring by-products present are significantly reduced.

What is claimed is:

1. A base catalysed process for the preparation of linear or branched siloxane polymers and copolymers, by the ring-opening polymerisation of macrocyclic cyclosiloxane oligomers having from 7 to 10 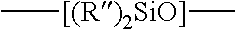
units per molecule, wherein each R″ group per unit is the same or different and is an alkyl group having from 1 to 6 carbons; which base catalysed process comprises the steps of
(a) introducing
(a) said macrocyclic cyclosiloxane oligomers in an amount of from 50 to 99 wt. % of the starting ingredients with
(ii) one or more end-blockers in an amount of from 1 to 50 wt. % of the starting ingredients and optionally
(iii) a co-monomer selected from a linear organosiloxane co-monomer, a branched organosiloxane co-monomer or cyclosiloxane co-monomer wherein said cyclosiloxane co-monomer has from 3 to 10 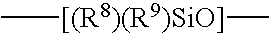
units per molecule, wherein each R⁸ group is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸;
said co-monomer (iii), when present being present in an amount of from 1 to 50 wt. % of the starting ingredients;
into a mixing vessel and mixing;
(b) optionally introducing an organic solvent in an amount of up to 7.5 wt. % of the starting ingredients into the mixing vessel during or subsequent to step (a);
(c) heating said starting ingredient (i) to a predetermined reaction temperature of from 25 to 160° C. in an inert atmosphere before introducing component (ii) and optionally component (iii), when present, or
heating a mixture of starting ingredients (i), (ii) and optionally (iii) to a predetermined reaction temperature of from 25 to 160° C. in an inert atmosphere;
(d) once the desired temperature has been reached, and starting materials (i),
(ii) and optionally (iii) are thoroughly mixed together, introducing a final starting ingredient, a base catalyst (iv) in an amount of from 0.001 to 10 wt. % of the starting ingredients; thereby forming an initial reaction mixture;
(e) agitating the initial reaction mixture at the predetermined reaction temperature for up to 24 hours until a step (e) product within a desired number average molecular weight range and/or a cyclics equilibration is obtained;
(f) quenching the reaction after step (e) by either filtering off heterogeneous base catalysts when used or with a suitable neutralising agent to form a step (f);
(g) Cooling the step (f) product to ambient temperature to form a cooled step (g) product and optionally,
(h) Stripping volatile cyclosiloxanes the cooled step (f) product to give a final linear or branched siloxane polymer or copolymer.

2. The base catalysed process for the preparation of linear or branched siloxane polymers and copolymers in accordance with claim 1 wherein the macrocyclic cyclosiloxane oligomers (i) comprise one or more oligomers of the structure [(CH₃)₂)SiO]_{n″}, [(C₂H₅)₂)SiO]_{n″}, [(C₃H₇)₂)SiO]_{n″}, [(CH₃)(C₂H₅)SiO]_{n″} and/or [(CH₃)(C₃H₇)SiO]_{n″} where n″ is from 7 to 10.

3. The base catalysed process for the preparation of linear or branched siloxane polymers and copolymers in accordance with claim 1, wherein the macrocyclic cyclosiloxane oligomers (i) comprises an oligomer consisting of seven —[(R″)₂SiO]-units per molecule, wherein each R″ group per unit is the same or different and is an alkyl group having from 1 to 6 carbons.

4. The base catalysed process for the preparation of linear or branched siloxane polymers and copolymers in accordance with claim 1, wherein the macrocyclic cyclosiloxane oligomers (i) comprise or consist of tetradecamethylcycloheptasiloxane, tetradecaethylcycloheptasiloxane, tetradecapropylcycloheptasiloxane, cyclohepta(methylethyl)siloxane, cyclohepta(methylpropyl)siloxane and mixtures thereof.

5. The base catalysed process for the preparation of linear or branched siloxane polymers and copolymers in accordance with claim 1, wherein end-blockers (ii) comprise one or more dimethyl alkenyl-terminated polydimethylsiloxanes having a degree of polymerisation of from 10 to 350, trialkyl-terminated polydimethylsiloxanes or one or more disiloxanes.

6. A The base catalysed process for the preparation of linear or branched siloxane polymers and copolymers in accordance with claim 1, wherein the end-blocker (ii) is selected from dimethyl vinyl-terminated polydimethylsiloxanes having a degree of polymerisation of from 10 to 100, dimethyl hexenyl-terminated polydimethylsiloxanes having a degree of polymerisation of from 100 to 350, trimethyl-terminated polydimethylsiloxanes having a viscosity of from 15 to 200 mPa·s at 25° C., hexamethyldisiloxane, 1,1,3,3-tetramethyldisiloxane, and 1,3-divinyltetramethyldisiloxane.

7. A The base catalysed process for the preparation of linear or branched siloxane polymers and copolymers in accordance with claim 1, wherein co-monomer (iii) comprises or consists of a cyclosiloxane co-monomer having from 3 to 10. 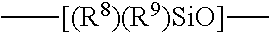
units per molecule, wherein each R⁸ group per is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸.

8. The base catalysed process for the preparation of linear or branched siloxane polymers and copolymers in accordance with claim 1, wherein co-monomer (iii) comprises or consists of a trialkyl silyl-terminated and/or dialkylsilanol terminated linear or branched organopolysiloxane comprising units of the structure 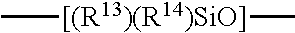
units per molecule, wherein each R¹³ group per is the same or different and is selected from an alkenyl group, an alkynyl group, an aryl group, a fluoroalkyl such as trifluoropropyl or a perfluoroalkyl group or a primary or secondary amine groups or alkyl ethylenediamine groups and each R¹⁴ group is selected from an alkyl group having from 1 to 6 carbons or R¹³.

9. The base catalysed process for the preparation of linear or branched siloxane polymers and copolymers in accordance with claim 1, wherein an organic solvent is present in an amount of up to 7.5 wt. % of the starting ingredients and is added into the mixing vessel during or subsequent to step (a).

10. The base catalysed process for the preparation of linear or branched siloxane polymers and copolymers in accordance with claim 9 wherein the organic solvent concerned is a linear, branched or cyclic aliphatic hydrocarbon which may optionally be chlorinated, a linear, branched or cyclic ether or an aromatic solvent.

11. The base catalysed process for the preparation of linear or branched siloxane polymers and copolymers in accordance with claim 1, wherein in step (c) the mixture of starting ingredients is heated to a reaction temperature of from >25° C. to 125° C., in an inert atmosphere.

12. A The base catalysed process for the preparation of linear or branched siloxane polymers and copolymers in accordance with claim 1, wherein the base catalyst (iv) is selected from
(I) an alkali metal hydroxide;
(II) alkali metal alkoxides or complexes of alkali metal hydroxides and an alcohol wherein the alkali metal is sodium, potassium, caesium or rubidium;
(III) an alkali metal trialkyl silanolate 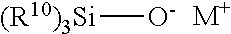
wherein each R¹⁰ group may be the same or different and is an alkyl group having from 1 to 6 carbons and M is an alkali metal group selected from sodium, potassium cesium and rubidium;
(IV) a polymeric or oligomeric silanolate of the structure 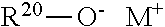
where M is as described above and R²⁰ is an organopolysiloxane chain;
(V) a Non-metallic silanolate;
(VI) phosphazene bases, or
(VII) a suitable alkoxide, e.g., a metal alkoxide such as an alkali earth alkoxide or organic alkoxide; or
(VIII) ammonia.

13. The base catalysed process for the preparation of linear or branched siloxane polymers and copolymers in accordance with claim 1, wherein the base catalyst (iv) is selected from sodium hydroxide, potassium hydroxide, cesium hydroxide or rubidium hydroxide, alternatively sodium hydroxide or potassium hydroxide; an alkali metal trialkyl silanolate 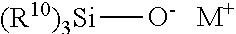
wherein each R¹⁰ group is the same or different and is an alkyl group having from 1 to 6 carbons and M is sodium or potassium; or a polymeric or oligomeric silanolate of the structure
R²⁰—O⁻M⁺
where M is selected from sodium, potassium, caesium or rubidium and R²⁰ is an organopolysiloxane chain, of the structure: 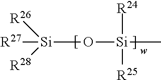
In which each R²⁴ may be the same of different and comprises an alkyl group having from 1 to 10 carbons, or a substituted alkyl group containing chloro substituted alkyl groups or fluoro substituted alkyl groups; each R²⁵ may be the same or different and may be R²⁴ or an alkenyl group having from 2 to 10 carbons alternatively an ethynyl group; an aromatic group, or an alkoxy group having from 1 to 10 carbons, Each of R²⁶, R²⁷ and R²⁸ may be the same or different and may be a hydroxyl group or R²⁵ and each w is integer of from 2 and 150, when introduced into the composition as starting ingredient (iv).
tetramethylammonium trimethylsilanolate [(CH₃)₄N—OSi(CH₃)₃], tetraethylammonium trimethylsilanolate, tetrapropylammonium trimethylsilanolate, tetramethylammonium triethylsilanolate, tetraethylammonium triethylsilanolate, tetrapropylammonium triethylsilanolate, tetramethylammonium tripropylsilanolate, tetraethylammonium tripropylsilanolate and/or tetrapropylammonium tripropylsilanolate.

14. The base catalysed process for the preparation of linear or branched siloxane polymers and copolymers in accordance with claim 1, wherein no organic solvent is introduced into the mixing vessel during or subsequent to step (a).

15-17. (canceled)
